(19) United States
(12) Patent Application Publication
(10) Pub. No.: US 2026/0220028 A1
(43) Pub. Date: Jul. 30, 2026

(54) SYSTEMS AND METHODS FOR A TESTING PIPELINE OF CODE GENERATION ARTIFICIAL INTELLIGENCE AGENTS

(71) Applicant: Salesforce, Inc., San Francisco, CA (US)

(72) Inventors: Jiacheng Xu, Sunnyvale, CA (US); Bo Pang, Los Angeles, CA (US); Jin Qu, San Mateo, CA (US); Hiroaki Hayashi, Palo Alto, CA (US); Yingbo Zhou, Palo Alto, CA (US); Caiming Xiong, Menlo Park, CA (US)

(21) Appl. No.: 19/253,686

(22) Filed: Jun. 27, 2025

Related U.S. Application Data
(60) Provisional application No. 63/751,524, filed on Jan. 30, 2025.

(51) Int. Cl. G06F 11/3668

(52) U.S. Cl. CPC G06F 11/3672

(57) ABSTRACT

Embodiments described herein provide a testing pipelines for LLM-based software engineering agents. For example, the testing pipeline comprise a variety of tasks to evaluate a software engineering agent's abilities in crafting test cases under specific requirements, ranging from relatively simple ones, such as completing assertion statements, to more complex challenges, like writing test cases to cover specific code blocks across up to ten files. The testing pipeline comprises a data collection module that collects test programs, and a testing environment construction module that run the agent-generated programs on different repositories.

### CROSS REFERENCE

The application is a nonprovisional of and claims priority to U.S. provisional application No. 63/751,524, filed Jan. 30, 2025, which is hereby expressly incorporated by reference herein in its entirety.

### TECHNICAL FIELD

The embodiments relate generally to machine learning systems for code generation and software engineering, and more specifically to a testing pipeline of code generation artificial intelligence (AI) agents.

### BACKGROUND

AI agents, commonly known as AI agents or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI agents can assist with product recommendations, order tracking, and personalized shopping experiences. In information technology (IT) support, these agents can guide users through troubleshooting steps, helping them resolve software and hardware issues. Specifically, for network hazards, AI agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. For example, in addition to generating natural language texts, Large Language Models (LLMs) may generate code snippets automating repetitive tasks, and even suggesting optimizations. Based on natural language prompts, LLMs can generate programming codes in writing functions, debugging errors, and refactoring code across various programming languages. However, evaluating such LLM-generated programming code, such as whether it accurately executes a target task, remains a challenge.

### BRIEF DESCRIPTION OF THE DRAWINGS

FIG. 1 shows a simplified diagram illustrating an example software engineering pipeline using various different software engineering agents, according to embodiments described herein.

FIGS. 2A-2D collectively show simplified diagrams illustrating an example testing pipeline for evaluating the testing agents on testing source files generated by the coding agents, according to embodiments of the present disclosure.

FIGS. 3A-3C illustrating different types of tasks adopted by the pipeline of FIGS. 2A-2D to evaluate testing agents, according to embodiments described herein.

FIG. 4 is a simplified diagram illustrating a computing device implementing the testing pipeline described in FIGS. 1-3C, according to one embodiment described herein.

FIG. 5 is a simplified diagram illustrating the neural network structure implementing the SWE testing module described in FIG. 4, according to some embodiments.

FIG. 6 is a simplified block diagram of a networked system suitable for implementing the SWE testing framework described in FIGS. 1-5 and other embodiments described herein.

FIG. 7 is an example logic flow diagram illustrating a method of operating a structured testing pipeline for validating a code generation artificial intelligence (AI) agent based on the framework shown in FIGS. 1-6, according to some embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

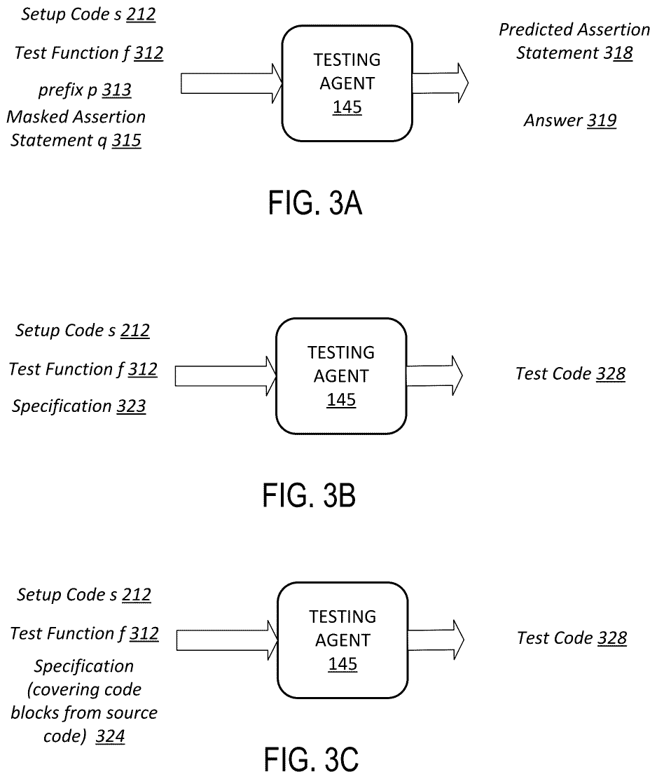

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 3.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Traditionally, LLM-generated compute code may be tested and/or evaluated by (1) evaluating LLMs on coding problems from coding competitions or on a single file setting; (2) evaluating LLMs under pull requests driven test case generation. In the first setting, the coding problem is capsuled in typically tens lines of code along with clear instructions, which has a huge gap between real-world software engineering and testing use cases. In contrast, the later setting is more realistic but also more complicated to handle. However, it has been typically limited to program repair or issue resolution, which fails to cover the vanilla software testing setting in dev lifecycle where the developer asks for a test method for focal method or for coverage increasing.

Embodiments described herein provide a testing pipelines for LLM-based software engineering agents. For example, the testing pipeline comprise a variety of tasks to evaluate a software engineering agent's abilities in crafting test cases under specific requirements, ranging from relatively simple ones, such as completing assertion statements, to more complex challenges, like writing test cases to cover specific code blocks across up to ten files. The testing pipeline comprises a data collection module that collects test programs, and a testing environment construction module that run the agent-generated programs on different repositories.

Therefore, in this way, the automated testing framework may validate code generation, debugging, and refactoring capabilities, helping to detect logical errors, security vulnerabilities, and inefficiencies early in development. Continuous integration and deployment (CI/CD) pipelines of testing may allow iterative improvements, refining the software agent's decision-making process based on real-world feedback. Additionally, the testing pipeline may provide a benchmark against diverse programming challenges so as to enhance generalization and robustness of AI-driven software development. AI technology in automatic software engineering is thus improved.

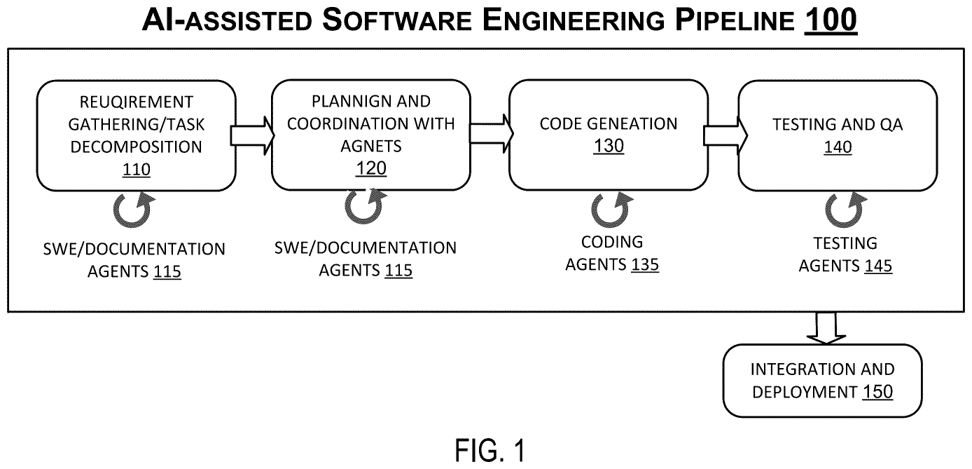

FIG. 1 shows a simplified diagram illustrating an example software engineering pipeline using various different software engineering agents, according to embodiments described herein. An AI-assisted software engineering pipeline 100 may use one or more LLM-based agents to automate specific engineering tasks with language models. For example, at requirement gathering and/or task decomposition stage 110, LLM agents such as SWE or documentation agents 115 may gather and analyze requirements by processing input from users or documents, and in turn convert natural language descriptions into structured specifications for software engineering. The overall software specification may be decomposed, e.g., by an LLM agent 115, into smaller and modular tasks, e.g., into agent-manageable components.

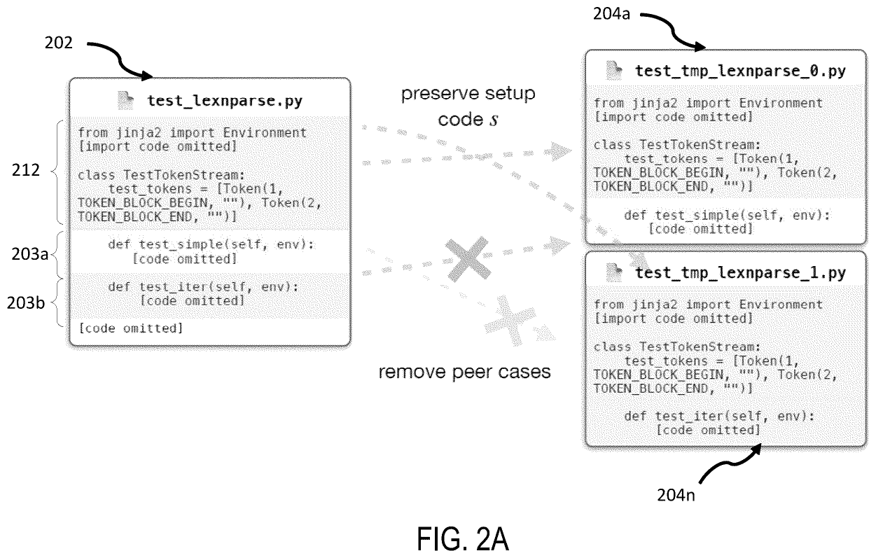

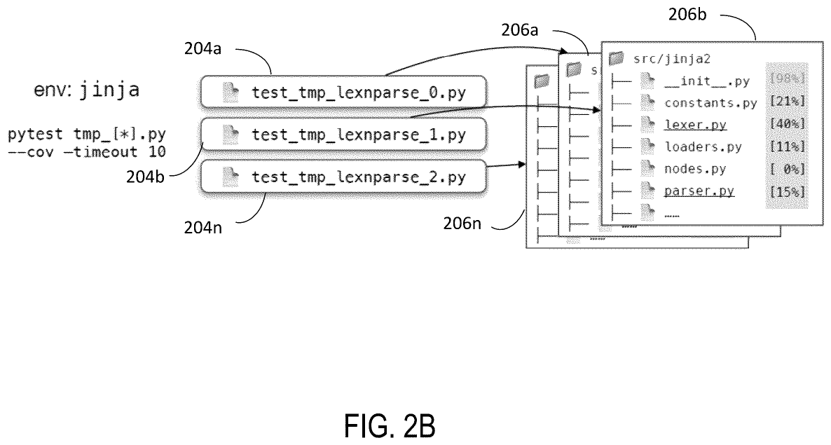

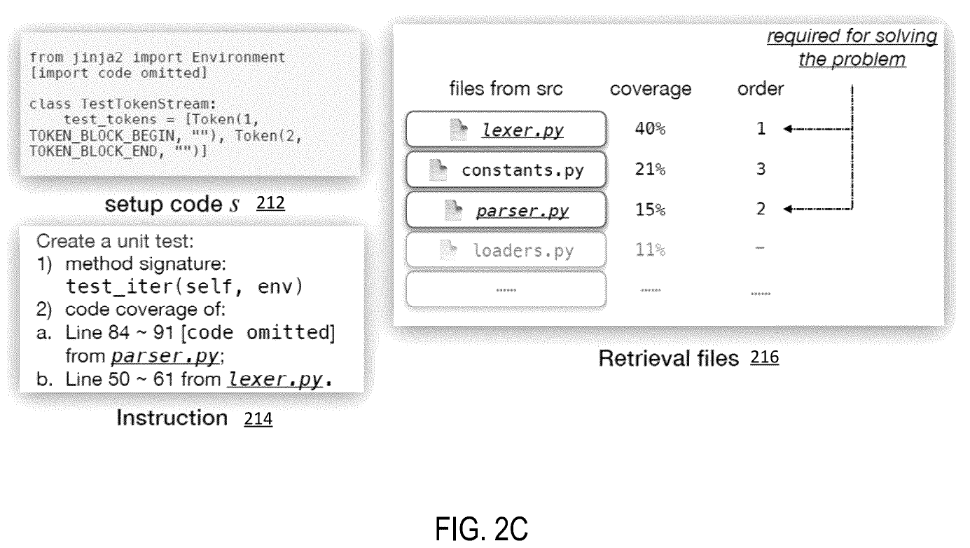

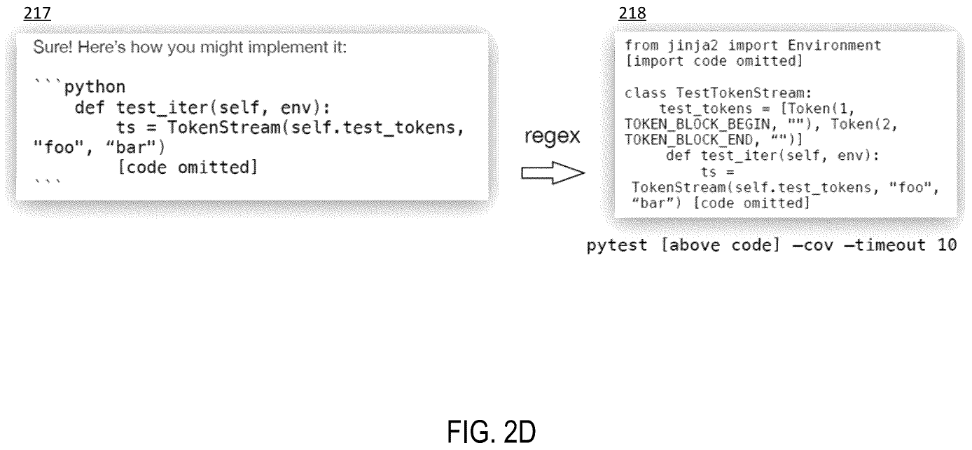

At planning and coordination stage 120, these decomposed software engineering tasks may then be assigned to agents with roles such as coding, testing, or documentation. For example, at the code generation stage 130, coding agents 125 may generate code programs based on the software specifications for each task so as to build each software module. Coding agents 135 may also modify or refactor code as needed. At testing and quality assessment stage 140, testing agents 145 may write and execute tests to verify correctness, completeness and/or other quality metrics with the generated code. For example, the testing agents 145 may be evaluated by generating test cases following an automatic pipeline having an execution environment, e.g., built by obtaining repositories from a codebase such as GitHub. The automatic pipeline may evaluate the testing agents 145 by generating test cases for code programs from the existing codebase and verified to identify candidate problems. Additional example of the automatic pipeline to evaluate and select a testing agent 145 for software engineering may be described in relation to FIGS. 2A-2D.

Upon testing, the software code may be integrated and/or deployed onto a computing environment 150. Communication between agents 115, 135 and 145 may be managed through a shared memory or messaging system. The process of pipeline 100 may be iterative and may continue with updates based on updated requirements or feedback from runtime.

FIGS. 2A-2D collectively show simplified diagrams illustrating an example testing pipeline for evaluating the testing agents 145 on testing source files generated by the coding agents 135, according to embodiments of the present disclosure. As shown in FIG. 2A, testing cases 202 may be obtained from one or more codebases, such as GitHub. For example, a plurality of Python repositories may be scraped to select a subset for use. Example repositories downloaded from the codebase may excluded for several reasons, including lack of support for pytest and/or pytest-cov, failures in automatic environment configuration or test case extraction, and non-standard naming conventions that disrupted heuristic-based test identification. The rule-based approach for locating source and test folders also failed in cases with unconventional project structures; for example, the elasticsearch-py repository uses elasticsearch and test_elasticsearch as its source and test directories, respectively. Additional exclusion factors included excessive evaluation time, runtime issues, and dependencies on external setup, non-Python components, or specific system configurations. In this way, source and test code folders may be identified by matching filenames against the pattern test *.py. Test modules may be defined as files containing at least one test function.

In one embodiment, each obtained testing file 202 may be segmented into one nor more 204a-b self-contained test cases such that each segmented test file 204a-n corresponds to an individual testing problem. In the example shown in FIG. 2A, the original testing case 202 may include the setup source code segment 212, and different code segments for peer testing cases 203a-n. To test a test function test_iter, which covers the use of Token and TokenStream classes from the source code 212, each extract case file 204a-n may preserve the setup source code 212 and at least one code segment for peer testing cases 203a-n while removing other peer cases.

In one embodiment, continuing on with FIG. 2B, the extracted case(s) 204a-n may be verified by running pytest to test the coverage on the source files. For each segmented testing case 204a-n, a coverage report 206a-c may be generated indicating coverage information associated with each of the testing case 204a-n covering a list of source files. For example, report 206b indicates the coverage percentages by the testing file 204b towards different source files.

For example, within an obtained testing file 202, test cases are represented as Y={y₁, y₂, . . . , y_{T}}, typically sharing common setup code 212 and organized around a unified testing objective. The full set of source files src is denoted as X={x₁, x₂, . . . , x_{F}}. When applying the verify API on T, a coverage tensor is obtained, e.g., [symbol] ∈{1, 0}^{T×F×L}, where C_{t,ƒ,i}=1 indicates test case yₜ covers the l-th line of file x_{ƒ}, and C_{t,ƒ,i}=0 otherwise. T=|Y| represents the total number of test cases in this file, F=|X| is the total number of source files, and L is the max number of lines in src. pytest-cov may be run two times for each test case yₜ: a regular run

$${C}_{t}^{base}$$

this will return the reguiar coverage report (e.g., 206b) of yₜ (e.g., 204b) over X; and empty run

$${C}_{t}^{empty}$$

in this setting, the code may be replaced with an empty test statement: def test( ): assert True and it will be deployed to the same location of yₜ. For instance, if test_iter was implemented in tests/util, the empty test may be deployed to that directory as well.

In one embodiment, a repository baseline may be established by comparing

$$\begin{matrix}{C}_{t}^{base} and {C}_{t}^{empty} \\ {Q}_{t}^{repo} = \{ {x}_{f} \vert {arg}_{f} [ \text{?} ( {C}_{t , f}^{base} = {C}_{t , f}^{empty} ) ] \}\end{matrix}$$

ere [symbol] (⋅) is the indicator function. The set

$${Q}_{t}^{repo}$$

comprises the files x_{ƒ} for which, for any test case index t, the coverage remains unchanged after executing the actual test case. This implies that the files in

$${Q}_{t}^{repo}$$

otter minimal information gain in terms of entropy for generating test case yₜ.

In one embodiment, to identify the most distinctive information across test cases, for a particular test case yₜ, the Peer Baseline is defined as follows

$${Q}_{t}^{peer} = \{ {x}_{f} \vert {arg}_{f} [ \text{?} ( {\sum }_{{t}^{′} = 1}^{T} {C}_{{t}^{′} , f , l}^{base} = 1 ) ] \}$$

ere [symbol] (⋅) is the indicator function.

$${\sum }_{{t}^{′} = 1}^{T} {C}_{{t}^{′} , f , l}^{base} = 1$$

ensures that the line l is covered by exactly one test case (test case yₜ), meaning it's only covered by the test case yₜ Next, Q′, which is the set not meeting the criteria for either Q^{peer} or Q^{repo}:

$${Q}_{t}^{′} = F ∖ ( {Q}_{t}^{repo} ⋃ {Q}_{t}^{peer} )$$

is obtained. The value of files in Q′ may be lower than those in Q^{peer} but higher than the repository baseline Q^{repo}.

Therefore, calibration of coverage of source files may be classified into three categories: Q^{repo}, Q^{peer}, and Q′. The approach for assembling context for test case t gives precedence to files in the order of

$${Q}_{t}^{peer} ,$$

followed by Q′ₜ, and ultimately

$${Q}_{t}^{repo} .$$

Within each category, source files may be randomly selected for testing if the context budget does not permit using them all.

In one embodiment, moving on with FIG. 2C, the setup code 212 from the testing file 202, together with a task instruction 214 for testing (e.g., on how to create a unit test as shown in FIG. 2D), and retrieved source files 216 according to their respective coverage by the testing files 204a-n may be used to assemble task prompts for the testing agent 145. For example, for one task instance, three categories of contents may be incorporated into the input to a testing agent 145, a task instruction 214 describing the task the testing agent 145 is to complete; an in-file code including setup code s 212 that prepares necessary components, such as imports, fixtures, and any initial configurations, required for the test and a function declaration ƒ that specifies the function's name, arguments, and any return types, if applicable; and source files 216 per task requirement which is retrieved from a source file repository.

Specifically, the task instruction 214 may specify one or more different types of tasks, e.g., (i) Task I—the testing agent 145 may perform mask prediction in assertion statements; (ii) Task II: targeted test implementation-given a target python class or function from the source file, the testing agent 145 needs to complete the test code by using the target; (iii) Task III—coverage oriented test implementation—given some code blocks from source code, the testing agent 145 may need to complete the test code and cover those target blocks. Additional details of the tasks may be described in FIGS. 3A-3C.

For example, FIG. 2C shows an example testing task of coverage-oriented test implementation, where for a specific testing problem, source files lexer.py and parser.py are retrieved, and task instruction 214 describes how to create a unit test to cover specific lines of the retrieved source files parser.py and lexer.py.

In one embodiment, to retrieve source files 216, an executable environment and a coverage API may be utilized to generate detailed coverage data of source files (e.g., coverage reports 206a-n). The setup is designed to (1) approximate near-upper-bound model performance and (2) evaluate model capabilities in long-context scenarios. The resulting long contexts arise naturally and require multi-hop code comprehension and effective use of contextual information, making the setup well-suited for software agent development. Files such as _init_.py often exhibit high coverage across test cases but contribute minimal problem-specific value. Due to their high coverage rates, these files can quickly exhaust the context budget without improving test relevance. To address this, coverage data is calibrated to emphasize files that are both informative and relevant. The objective of the retrieval component is to maximize the informativeness of content included within a limited context window.

In one embodiment, moving on with FIG. 2D, the testing agent 145 may generate a response given the task prompt combining the setup code 212, task instruction 214 and retrieved source files 216. In some implementations, two settings, Problem Only (PO) and Contextual may be adopted in different testing: in Problem Only setting, only the task instruction 214 and in-file code including setup code 212 are provided to the testing agent 145. In contextual setting, code snippets from source files capped by context budget are also provided.

For example, as shown in FIG. 2D, the testing agent 145 may generate a unit test method of a test function test_iter 217, based on which the testing agent 145 may generate a unit test class 218 for testing the TokenStream class. The generated unit test class 218 may then be used to run test with Python test suite.

In one embodiment, the automated testing pipeline shown in FIGS. 2C-2D may execute new unit tests may be performed via verification application programing interfaces (APIs). During development of the verify API, several considerations were addressed: consistency checking to compare model-generated implementations against ground-truth code for identifying issues related to extraction, heuristics, or system conditions (e.g., caching); batchification to reduce overhead from repeated test framework initialization; timeout management to prevent infinite loops in generated code; robust error handling and logging; and repository restoration to ensure the environment is reset before and after each test. The verification process is encapsulated in the API verify (case)→{true, false}, where the output indicates whether the test case executes successfully. The cov API provides line-level coverage metrics for a test case using pytest-cov, reporting hit and missed lines and computing file-level coverage even in the event of execution failure. Unlike verify, the cov API does not support parallelization due to shared cache dependencies, but it can still generate reports for failed test cases.

To execute test programs across multiple repositories, isolated sandboxes are created and encapsulated within a Docker image to ensure minimal manual intervention and enable scalability. The process begins by setting up a conda virtual environment with Python 3.10. Package dependencies are then installed by processing requirements.txt files and attempting installation via pip. Git submodules are initialized and updated if present. Following this, the repository is installed using multiple methods, including pip, poetry, and tox, in an attempt to cover various packaging conventions. After installation, pytest is executed to determine whether a sufficient number of test cases can be successfully discovered and executed. This automated procedure successfully configured the environments for 25 out of 42 repositories (59.5%) in practice.

In one embodiment, tasks are executed sequentially, while evaluations within each task are conducted concurrently across repositories. The overall evaluation time is bounded by the longest-running repository, which constitutes the primary bottleneck. To constrain total runtime to two hours per model on a CPU-based Linux system, the number of examples per repository is capped, e.g., 50 for Task I, and 25 for Tasks II and III.

FIGS. 3A-3C illustrating different types of tasks adopted by the pipeline of FIGS. 2A-2D to evaluate testing agents 145, according to embodiments described herein. As shown in FIG. 3A, a task challenges the testing agent 145 to predict the missing element in an assertion statement within a test case, addressing the code completion feature offered by coding companions. For example, for each problem x, the task prompt has following elements in the prompt of the task [s, ƒ, p, q, ref] in the Problem-Only setting, where s represents that setup code 212 described in FIG. 2A, ƒ represents the test function 312 (e.g., test_iter in FIG. 2A) associated with the problem, prefix p 313 represents the existing code within the test function ƒ, serving as the context for solving assertion statements; and assertion statement (e.g., a debugging aid that tests whether a given condition is true) with a MASK (q) 315 represents the task for models to complete. For example, Cloze construction AST tools may identify all possible assertion statements, including unary (e.g., variables, functions) and binary operations (comparisons). For binary, either operand can be masked. The suffix of q is removed to avoid hints, ensuring q is the last code line.

For example, an example task prompt for the masked prediction task in a Problem Only setting may take a form similar to:

### Task Overview

You need to complete the assertion in the provided unit test method by considering the context from the corresponding
Python file.

### Context Information

Below is the file context, which includes necessary imports and setups for the unittest:
{{context}}

### Target Unit Test Method

This is the unit test method for which you need to complete the assertion statement:
{{prefix}}

### Your Task

Right after the above code block, you need to predict and fill in the blank (cloze key) in the following assertion
statement:
{{cloze_question}}
Use the context and the provided prefix in the unit test method to infer the missing part of the assertion.

### Output Format

Your output should be a finished assertion statement. Do not generate the entire unit test method; only produce the
assertion statement.

### Example

For instance, if the cloze question is assert==(25, 25, 75, 75), and your prediction for the blank is im.getbbox (alpha only=False), your output should be:
assert im.getbbox (alpha_only=False)==(25, 25, 75, 75)
Please provide your output in the desired format without additional explanations or step-by-step guidance.

### Notes.

The completed assertion should not be trivial. For instance, assert True==True and assert
   str (“a”)==“a” are considered trivial assertions.
There will be precisely one blank in the assertion statement to be filled in.

Based on the surrounding code and any referenced materials, the testing agent 145 is expected to generate a predicted assertion statement 318 with all the masked elements filled. A reference answer (ref) is the original answer from the code 212, which may be used to verify the generative quality of the coding agent 145.

Therefore, the testing agent 145 may rely solely on the problem details, without extensive information about the method under test to predict the masked elements.

Given a set of code repositories (e.g., original code repository files 202 obtained from a codebase), there exists certain high frequent assertion statements, which provides unwanted hint to models. For instance, “200” (string literal) and 200 (number) are the most frequent candidates for the MASK. So problems may be filtered with common ref. The chosen probability of a problem xi is thus defined as:

$$p ( {x}_{i} ) = \{ \begin{matrix}0 , & if \frac{count ( {ref}_{i} )}{N} > 0.01 \\ \frac{len ( {ref}_{i} )}{{\sum }_{j = 0}^{N} len ( {ref}_{j} )} & otherwise\end{matrix}$$

where N is the total number of problems in one repository. The problems may be downsampled, e.g., to 50 problems per repository to maintain a diverse set of problems.

In one embodiment, for the masked prediction task shown in FIG. 3A, two elicitation methods may be implemented: (1) answer only (pred): the testing agent 145 yields the answer 319 directly in a code block; (2) assertion statement with answer filled q.replace (MASK, pred): the coding agent 145 returns the line (e.g., predicted assertion statement with masked elements filled 318) with blank filled.

For example, an example task prompt for the masked prediction task in a Problem Only setting may take a form similar to:

### Task Overview

You need to complete the assertion in the provided unit test method by considering the context from the corresponding
Python file.

### Context Information

Below is the file context, which includes necessary imports and setups for the unittest:
{{context}}

### Target Unit Test Method

This is the unit test method for which you need to complete the assertion statement:
{{prefix}}

### Your Task

Right after the above code block, you need to predict and fill in the blank (cloze key) in the following assertion
statement:
{{cloze_question}}
Use the context and the provided prefix in the unit test method to infer the missing part of the assertion.

### Output Format

Your output should be a finished assertion statement. Do not generate the entire unit test method; only produce the
assertion statement.

### Example

For instance, if the cloze question is assert==(25, 25, 75, 75), and your prediction for the blank is im.getbbox (alpha only=False), your output should be:
assert im.getbbox (alpha_only=False)==(25, 25, 75, 75)
Please provide your output in the desired format without additional explanations or step-by-step guidance.

### Notes.

The completed assertion should not be trivial. For instance, assert True==True and assert
   str (“a”)==“a” are considered trivial assertions.
There will be precisely one blank in the assertion statement to be filled in.

For another rexample, a task prompt for the masked prediction task in a Contextual setting may take a form similar to:

### Task Overview

You need to complete the assertion in the provided unit test method by considering the context from the corresponding Python file.

### Retrieved Code Snippets for Reference

Here are a few code snippets retrieved for your reference while making your prediction:
{{retrieved_snippet}}

### Context Information

Below is the file context, which includes necessary imports and setups for the unittest:
{{context}}

### Target Unit Test Method

This is the unit test method for which you need to complete the assertion statement:
{{prefix}}

### Your Task

Right after the above code block, you need to predict and fill in the blank (cloze key) in the following assertion
statement:
{{cloze_question}}
Use the context and the provided prefix in the unit test method to infer the missing part of the assertion.

### Output Format

Your output should be a finished assertion statement. Do not generate the entire unit test method; only produce the
assertion statement.

### Example

For instance, if the cloze question is assert==(25, 25, 75, 75), and your prediction for the blank is im.getbbox (alpha only=False), your output should be:
assert im.getbbox (alpha_only=False)==(25, 25, 75, 75)
Please provide your output in the desired format without additional explanations or step-by-step guidance.

### Notes

1. The completed assertion should not be trivial. For instance, assert True==True and assert
   str (“a”)==“a” are considered trivial assertions.
2. There will be precisely one blank in the assertion statement to be filled in.

Continuing on with FIG. 3B, the testing agent 145 may, given a python class or function from the source code, complete the test code by using the target. Each problem instance includes a setup code s 212, a function declaration f 312, and a specification 323 that references the target class, for the testing agent 145 to generate a test code 328. For example, the specification template and an example may include target_name denotes the class or function name, type indicates whether it is a class or function, and file_name specifies the file in which the target is implemented.

In one embodiment, AST-based parsing is applied to extract all Attribute-type nodes via recursive traversal. Identified classes and functions are considered candidate targets and filtered against entries in

$${C}_{t}^{base}$$

A random target is slected as the requirement. File inclusion is controlled across input size settings (e.g., 8 k-64 k), ensuring the required file is included. The input length is constrained to a maximum of 8 k tokens, with a 4 k-token limit for output. Problems exceeding the total 12 k-token limit are discarded. A single target is set per case to maximize example inclusion.

In this task, the generated code 328 is the completion of the function declaration ƒ. An example prompt for generating the test code for a target class or function having the full code block (s, ƒ) along with the completion may take a form similar to the following:

### Task Overview

Create a unit test based on the provided method signature and given context. All necessary imports for the test have been included, so focus solely on writing the unit
test method. No additional libraries can be imported.

### Retrieved Code Snippets for Reference

Several code snippets have been provided for your reference:
{{retrieved_snippet}}
Hint: Depending on the target unit test method's signature, you might want to utilize or test these code snippets.
Requirement: Each retrieved code snippet must be used at least once in the final unit test method.

### Context Information

Below is the test code context, including necessary imports and setups for unittest:
{{context}}

### Signature of Target Unit Test Method

This is the unit test method signature you need to complete:
{{prefix}}

### Your Task

Continue writing the unit test method immediately following the provided method signature, ensuring to include at least one substantial assertion. Your task is to
replace “<YOUR CODE HERE>” with correctly indented code.

### Output Format

Please return the WHOLE FILE content (including the context and the completed unit test method, but not the Retrieved Code Snippets). You should not modify the
context part of the code.

### Example 1

class A:
def_init_(self):
self.a=1
self.b=2
def test_comparing_a_b ( )

### <YOUR CODE HERE>

def test_assert_b ( )
assert self.b==2
The output should follow the correct indentation principles. For example:
class A:
def_init_(self):
self.a=1
self.b=2
def test_comparing_a_b ( )
assert self.a==1 #Correct indentation with eight spaces before ‘assert’
assert self.a!=self.b #Correct indentation with eight spaces before ‘assert’
def test_assert_b ( )
assert self.b==2
Here is one WRONG example:
#wrong example
class A:
def_init_(self):
self.a=1
self.b=2
def test_comparing_a_b ( )
assert self.a==1 #Incorrect indentation
assert self.a!=self.b #Incorrect indentation
def test_assert_b( ):
return #YOU SHOULD NEVER modify the context code

### Example 2

def test_value_c( ):

### <YOUR CODE HERE>

The output should follow the correct indentation principles. For example:
def test_value_c ( ):
assert c==3
Keep in mind that the “<YOUR CODE HERE>” section lacks any leading spaces.—Ensure you include the appropriate amount of indentation before the ‘assert’
   statements.—If the method signature necessitates returning an object, implement that as well.

Continuing on with FIG. 3C, given some code blocks from source code, the testing agent 145 may complete the test code and cover those target blocks. Specifically, for each problem, the source code 212 and test function 312 [s,ƒ] and a specification 324 to cover up to one or more code blocks from the source code. The full code snippet may be provided in the “Retrieved Code Snippets for Reference” section of the prompt along with other retrieval files. In the specification prompt, the file name, the code blocks to cover, and the starting and ending line number for these code blocks in the original file. An example task prompt may take a form similar to:

### Task Overview

Create a unit test based on the provided method signature and given context. All necessary imports for the test have been included,
so focus solely on writing the unit test method. No additional libraries can be imported.

### Retrieved Code Snippets for Reference

Several code snippets have been provided for your reference:
{{retrieved_snippet}}

### Output Format

When completing a code snippet, the output should include the entire code context provided, including any imports, class
definitions, or function signatures. Replace placeholders with meaningful code that fits the context. Example:

### Given:

import pytest
from aiohttp import web
from aiohttp.web_urldispatcher import UrlDispatcher
@pytest.fixture
def router( )->UrlDispatcher:
return UrlDispatcher( )
def test_get (router: UrlDispatcher)->None:

### {{SYMBOL_YOUR_CODE}}

The goal is to complete the method test get (router: UrlDispatcher)->None: with correct indentation and
necessary logic while retaining the full context.
Example output:
import pytest
from aiohttp import web
from aiohttp.web_urldispatcher import UrlDispatcher
@pytest.fixture
def router( )->UrlDispatcher:
return UrlDispatcher( )
def test_get (router: UrlDispatcher)->None:
async def handler (request: web.Request)->NoReturn:
assert False
router.add_routes ([web.get (“/”, handler)])
route=list (router.routes( ))[1]
assert route.handler is handler
assert route.method==“GET”
Task with Context Provided
Below is the test code context, including necessary imports and setups for unittest. Following the method signature “method
signature”, you need to complete the unit test method. Ensure to include at least one substantial assertion.
Replace SYMBOL YOUR CODE with the correctly indented test code.
{{context}}
Hint: Depending on the target unit test method's signature, you might want to utilize or test these code snippets.

### Requirement:

Ensure you return the unit test method including the given method signature. Do not modify the method signature.
You are not allowed to import anything else as all necessary imports for the case have been provided.
Properly indent each line before including it.
Avoid using ANY trivial assertions such as assert True==True or assert str (“a”)==“a”, as they will
be deemed incorrect.
   {{coverage_requirement}}

In one embodiment, a deterministic approach may be applied to select code blocks from the source code rather than randomly choosing code spans. Cₜ^{peer} may guide the selection of code blocks to cover. For a case yₜ, if there is some code blocks only covered by it, not any other peer cases. Typically it's the case where a conditional branch or a function is hit by only one case. Code blocks may also be filtered out with fewer than 5 lines to avoid excessive code fragments. The max number of files to cover is set at 10. With this approach, the testing agent 145 may be guided with a feasible and reasonable coverage requirement which also aligns with the function name and arguments, to generate a test code 328.

### Computer and Network Environment

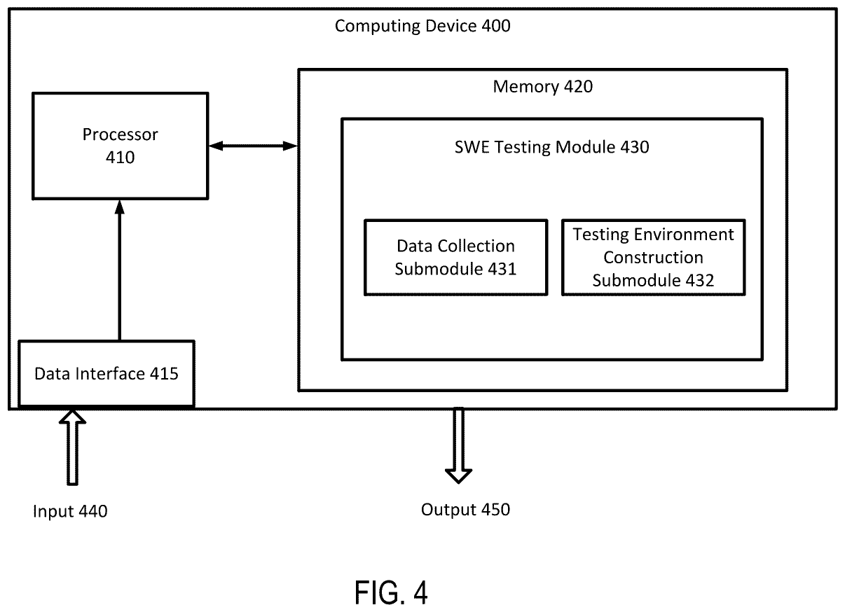

FIG. 4 is a simplified diagram illustrating a computing device implementing the testing pipeline described in FIG. 1, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 4B.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for SWE testing module 430 that may be used to implement and/or emulate the systems and models, and/or to implement any of the methods described further herein. SWE testing module 430 may receive input 440 such as an input training data (e.g., input-code pairs) via the data interface 415 and generate an output 450 which may be a code program, or an execution result of a generated code.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a code to be tested from a user via the user interface.

In some embodiments, the SWE testing module 430 is configured to collect testing case and conduct a testing of a model-generated code. The SWE testing module 430 may further include a data collection submodule 431 (e.g., as described in Sec. 4.1 in Appendix I), and a testing environment construction submodule 432 (e.g., as descried in Sec. 4.2 in Appendix I).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

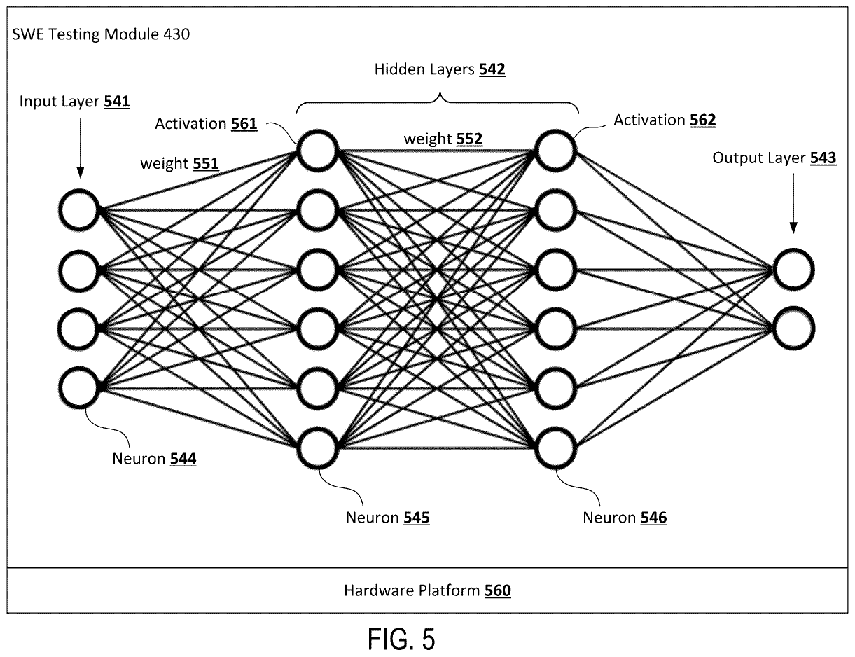

FIG. 5 is a simplified diagram illustrating the neural network structure implementing the SWE testing module 430 described in FIG. 4, according to some embodiments. In some embodiments, the SWE testing module 430 and/or one or more of its submodules 531-532 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 540 in FIG. 5), such as an input model-generated code. The number of nodes (neurons) in the input layer 541 may be determined by the dimensionality of the input data (e.g., the length of a vector of a natural language input). Each node in the input layer represents a feature or attribute of the input.

The hidden layers 542 are intermediate layers between the input and output layers of a neural network. It is noted that two hidden layers 542 are shown in FIG. 5 for illustrative purpose only, and any number of hidden layers may be utilized in a neural network structure. Hidden layers 542 may extract and transform the input data through a series of weighted computations and activation functions.

For example, as discussed in FIG. 4, the SWE testing module 430 receives an input 540 of a natural language input and transforms the input into an output 550 of a code program. To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the SWE testing module 430 and/or one or more of its submodules 531-532 may comprise the transformative neural network structure of layers of neurons, and weights and activation functions describing the non-linear transformation at each neuron. Such a neural network structure is often implemented on one or more hardware processors 510, such as a graphics processing unit (GPU). An example neural network may be Transformer based LLM, and/or the like.

In one embodiment, the SWE testing module 430 and its submodules 431-432 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached. In this way, output tokens may be autoregressively generated.

The generated sequence of tokens may jointly represent an output. For example, a Transformer-based LLM (such as LLM 110a-d) may receive a natural language input (such as a question) and generate a natural language output (such as an answer to the question).

In one embodiment, the SWE testing module 430 and its submodules 431-432 may be implemented by hardware, software and/or a combination thereof. For example, the SWE testing module 430 and its submodules 531-432 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 560 used to implement the neural network structure is specifically configured based on factors such as the complexity of the neural network, the scale of the tasks (e.g., training time, input data scale, size of training dataset, etc.), and the desired performance.

For example, to deploy the SWE testing module 430 and its submodules 431-432 and/or any other neural network models onto hardware platform 560, the neural network based modules 530 and its submodules 431-432 may be optimized for deployment by converting it to a suitable format, such as ONNX or TensorRT, to improve performance and compatibility. Next, depending on the size and workload requirements for modules 530 and its submodules 431-432, hardware types may be chosen for deployment, e.g., processing capacity, GPU memory size, and/or the like. Frameworks and drivers for the chosen hardware 560 frameworks and drivers may thus be installed, such as PyTorch, TensorFlow, or CUDA, to support the hardware platform 560. Then, weights and parameters of the SWE testing module 430 and its submodules 431-432 may be loaded to the hardware 560. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the SWE testing module 430 and its submodules 431-432 may be deployed as a service, then they may be integrated with an API endpoint, using tools like Flask, FastAPI, or a cloud platform serverless services, and is accessible by a remote user via a network.

In another embodiment, some or all of layers 541, 542, 543 and/or neurons 542, 545, 546, and operations there between such as activations 561, 562, and/or the like, of the SWE testing module 430 and its submodules 431-432 may be realized via one or more ASICs. For example, each neuron 542, 545 and 546 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the SWE testing module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based SWE testing module 430 and one or more of its submodules 431-432 may be trained by iteratively updating the underlying parameters (e.g., weights 551, 552, etc., bias parameters and/or coefficients in the activation functions 561, 562 associated with neurons) of the neural network based on the loss. For example, during forward propagation, the training data such as testing data are fed into the neural network. The data flows through the network's layers 541, 542, with each layer performing computations based on its weights, biases, and activation functions until the output layer 543 produces the network's output 550. In some embodiments, output layer 543 produces an intermediate output on which the network's output 550 is based.

The output generated by the output layer 543 is compared to the expected output (e.g., a “ground-truth” such as the corresponding give an example of ground truth label) from the training data, to compute a loss function that measures the discrepancy between the predicted output and the expected output. For example, the loss function may be cross entropy, MMSE. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

In one embodiment, the neural network based SWE testing module 430 and one or more of its submodules 431-432 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In some embodiments, SWE testing module 430 and its submodules 431-432 may be housed at a centralized server (e.g., computing device 500) or one or more distributed servers. For example, one or more of SWE testing module 430 and its submodules 431-432 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as evaluating a LLM-generated code relating to an unseen task.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in software engineering.

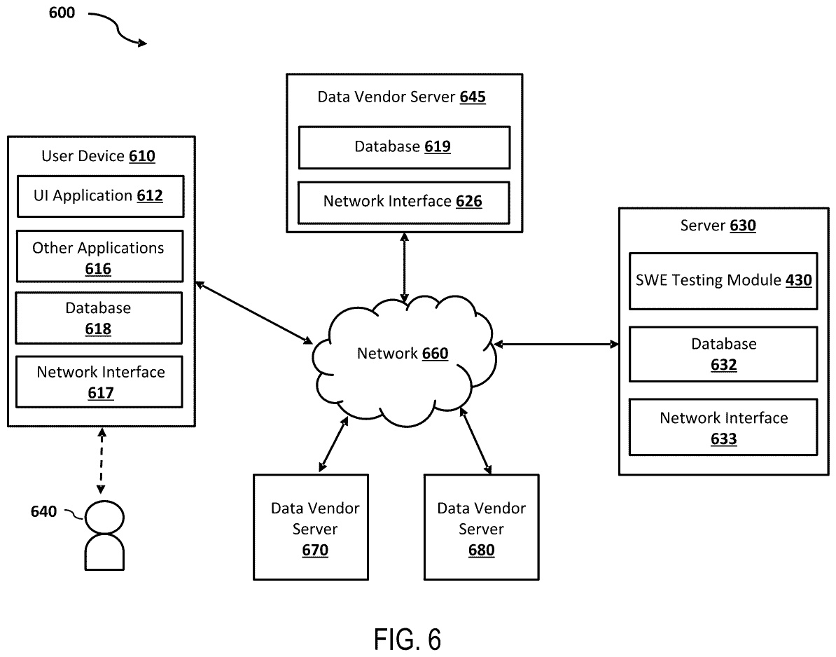

FIG. 6 is a simplified block diagram of a networked system 600 suitable for implementing the SWE testing framework described in FIGS. 1-5 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a testing result and/or a code generation result from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the SWE testing module 230 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which SWE testing module 230 may generate a response via the process described in FIG. 1. The SWE testing module 230 may thus cause a display at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view a generated code program, or a task execution result.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including testing cases from the data collection module to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the SWE testing module 230 and its submodules described in FIG. 2A. In some implementations, SWE testing module 230 may receive data from database 619 at the data vendor server 645 via the network 660 to generate task execution results. The generated task execution results may also be sent to the user device 610 for review by the user 640 via the network 660.

In one embodiment, an AI agent implementing the SWE testing module 430 and its submodules described in FIG. 6 may be built based on an LLM as described in FIG. 5. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the SWE testing module 430 and its submodules described in FIG. 6 may be implemented as a cloud-based AI agent which may be accessed by user device 610 via a chatbot application, a web application, customer support or SaaS applications. In another implementation, a client-side AI agent component may be delivered from the server 630 to user device 610 for local installation such that the client-side AI agent may be installed and runs directly on the user's device. Such local AI agent on the user device 610 may be available offline to adapt to privacy-sensitive applications. In another implementation, the AI agent implementing the SWE testing module 430 and its submodules described in FIG. 6A may adopt a hybrid cloud and client-based structure to balance computing speed, cost and privacy. For example, a local AI agent may handle basic AI queries locally, but complex queries may be sent to server 630 to process.

The database 632 may be stored in a transitory and/or non-transitory memory of the server 630. In one implementation, the database 632 may store data obtained from the data vendor server 645. In one implementation, the database 632 may store parameters of the SWE testing module 230. In one implementation, the database 632 may store previously generated testing cases, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

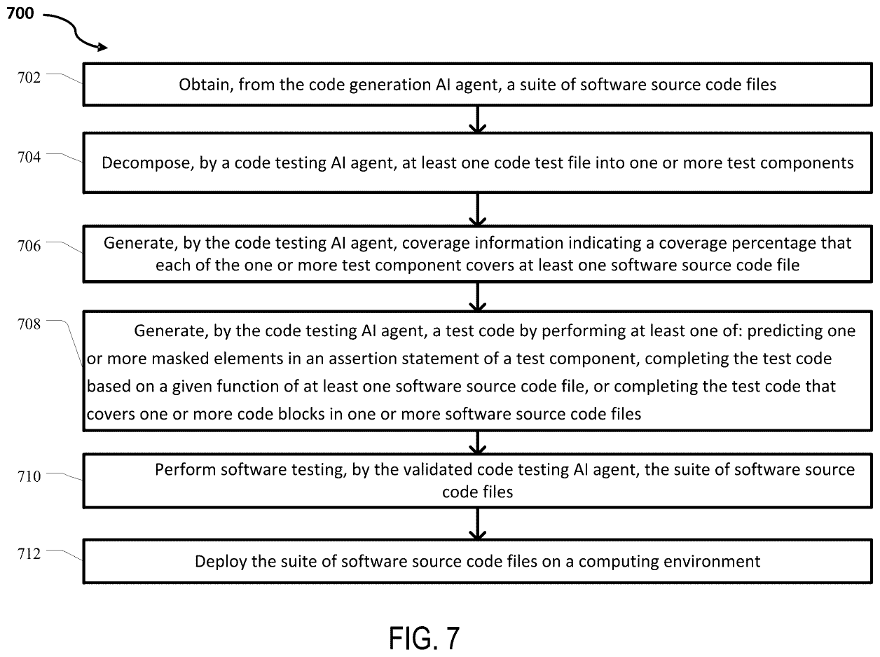

FIG. 7 is an example logic flow diagram illustrating a method of operating a structured testing pipeline for validating a code generation artificial intelligence (AI) agent based on the framework shown in FIGS. 1-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the SWE testing module 430 (e.g., FIGS. 4 and 6) that performs validating a code generation AI agent.

In some embodiments, method 700 is performed by a system such as computing device 400, user device 510, server 630, or another device or combination of devices. Inputs may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, a code generation AI agent (e.g., 135 in FIG. 1) may generate a suite of software source code files, e.g., during software development.

At step 704, a code testing AI agent (e.g., 145 in FIG. 1) may generate at least one code test file (e.g., 202 in FIG. 2A) into one or more test components (e.g., 204a-n in FIG. 2A). For example, each of the one or more test components (e.g., 202a-n in FIG. 2A) includes a shared setup code component (e.g., 212 in FIG. 2A) and a test function. Decomposing the at least one code test file includes preserving the shared setup code component and removing peer test functions from an individual test component.

At step 706, the code testing AI agent (e.g., 145 in FIG. 1) may generate coverage information (e.g., 206a-n in FIG. 2B) indicating a coverage percentage that each of the one or more test component covers at least one software source code file.

At step 708, the code testing AI agent (e.g., 145 in FIG. 1) may generate a test code (e.g., 218 in FIG. 2D) by performing at least one of: predicting one or more masked elements in an assertion statement of a test component (e.g., task described in FIG. 3A), completing the test code based on a given function of at least one software source code file (e.g., task described in FIG. 3B), or completing the test code that covers one or more code blocks in one or more software source code files (e.g., task described in FIG. 3C).

For example, in one implementation, the one or more masked elements in an assertion statement of a test component is predicted by the code testing AI agent (e.g., 145 in FIGS. 1 and 3A-3C) based on a task prompt combining a setup code component (e.g., 212 in FIG. 3A) and a test function (e.g., 312 in FIG. 3A) of at least one code component, the one or more masked elements (e.g., 315 in FIG. 3A), and at least one or more software source code files as a context.

For another example, in one implementation, the test code may be generated based on an input combining a setup code component (e.g., 212 in FIGS. 3B-3C) and a test function of at least one code component, a first specification describing the given function or a second specification describing one or more references to the one or more code blocks in the one or more software source code files and one or more code snippets relating to the test function as a context.

At step 710, the code testing AI agent may be evaluated based at least on an execution result of the test code. For example, in one implementation, for the task of masked prediction in assertion statement, the execution result comprises one or more of: a match rate that the predicted one or more masked elements match with the one or more masked elements; an execution rate that measures whether the assertion statement filled with the predicted one or more masked elements executes successfully; and a context utility rate that measures a performance change given a longer context. For another example, for the code completion task, the execution result comprises one or more of: an execution rate that measures whether the test code is executed successfully; and a success rate that measures whether the test code meets conditions in the first specification or the second specification.

In one implementation, the coding testing AI agent may be selected among candidate coding testing AI agents having a highest performance metric, e.g., as shown in Tables 1-4. In one implementation, a code testing AI agent may be discarded when the execution result fails to meet a pre-defined threshold.

At step 712, the code testing AI agent may perform software testing on the suite of software source code files.

At step 714, the suite of software source code files may be deployed on a computing environment. For example, the source code may be packaged into deployable artifacts (e.g., containers, binaries, or application bundles), with configured environment-specific parameters such as API endpoints or authentication keys. An appropriate infrastructure platform (e.g., cloud service, on-premises server, or edge device) may be selected depending on the complexity and/or operational requirement of the artifacts. Continuous Integration/Continuous Deployment (CI/CD) pipelines are often used to automate this step, ensuring version control, rollback safety, and monitoring integration. Once deployed, the software application is registered with system services, started with appropriate runtime permissions, and subjected to post-deployment validation to confirm operational readiness and service availability.

Advancements in automated software engineering technologies, particularly in intelligent code generation and testing, contribute to the overall improvement of computer technology by increasing development efficiency, software reliability, and system performance. By enabling precise, automated validation of software through AI-driven test generation and coverage analysis, these tools (such as code testing AI agent 145) reduce human error and accelerate the identification of defects and performance bottlenecks. This leads to the production of more optimized and stable software, which in turn reduces unnecessary hardware resource consumption such as CPU cycles, memory usage, and power draw. As a result, automated testing not only enhances software quality but also improves the operational efficiency of computing systems, extending hardware lifespan, reducing energy costs, and enabling more scalable and sustainable computing infrastructure.

### Data Experiments

Example data experiments are conducted to use the automated pipeline discussed in FIGS. 2A-2D to evaluate different LLMs acting as the testing agent 145. For the masked prediction task shown in FIG. 3A, let pred denote the model prediction for MASK. Three evaluation metrics are used: Exact Match (EM), defined as EM=1 (ref=pred); Execution Rate (ER), which measures whether the assertion statements filled with pred execute successfully; and Refined Execution Rate (RER), which builds on ER by applying post-processing to eliminate trivial assertions and prevent copying existing assertions from context. Post-processing removes cases where pred is a constant in a unary operation, a constant in a binary operation with another constant, or matches the opposite operand in an equation comparison. Constants are defined according to AST specifications. Since problems are selected based on surface length as a proxy for difficulty, the false negative rate is assumed to be low.

Additionally, Δ is defined to measure models' capability in effectively utilizing the context. On the performance gain side, Δₘₐₓ=max (r₄ₖ, r₈ₖ, . . . , r_{maxLen})−r₀ where r₀ is the context free baseline performance. Since context may be provided to the model to generate a test case, shorter context carrying strong hint could be sufficient and even better than longer sequence. Δₘₐₓ measures the best possible gain a model could get. Vice versa, Δₘᵢₙ=min (r₄ₖ, r₈ₖ, . . . , r_{maxLen})−r₀. This set of metrics focuses on the relative performance change given longer context. The ideal value, if context provides good source of information, for this metric follows this equation Δₘₐₓ>Δₘᵢₙ>0.

In this setting, only the problem itself is provided, without external context such as the code of the Method Under Test (MUT). Results are shown in Table 1. Among open-source models, QWEN 2.5CI-14B performs best, achieving results comparable to proprietary models, while CLAUDE 3.5-S outperforms all others across all metrics. To understand the gap between Exact Match (EM) and Refined Execution Rate (RER), we analyzed cases where predictions succeeded in execution (RER) but failed to match the ground truth exactly (EM). On average, model predictions were 25.8 characters long, compared to 30.7 characters for ground truth answers, indicating a tendency toward brevity or shorthand. Execution often succeeds despite mismatches due to factors such as the use of nonconstant unary assertions (e.g., assert pred), syntactic sugar (e.g., x in dict treated as x in dict.keys( )), string operations like strip, interchangeable quotation marks, or flexible assertions such as assert x not in y. The current execution-based evaluation lacks awareness of contextual semantics or user intent. Future work aims to build tools that evaluate predictions based on both execution outcomes and alignment with intended meaning.

TABLE 1
Model performance on Task I in the Problem-Only setting

| | EM | ER | RER |
|---|---|---|---|
| C_{ODE}G_{EMMA}-7_{B} | 30.3% | 46.5% | 43.7% |
| M_{AGICODER} 6.7B | 23.3% | 40.6% | 34.3% |
| C_{ODE}L_{LAMA}-13_{B} | 31.3% | 52.6% | 42.3% |
| S_{TAR}C_{ODER}2-15_{B} | 32.7% | 52.4% | 41.1% |
| MISTRAL-7B | 21.5% | 39.4% | 37.2% |
| Q_{WEN} 2.5CI-14B | 52.6% | 64.7% | 59.8% |
| CODESTRAL-22B | 45.5% | 68.2% | 63.3% |
| Y_{I}-C_{ODER}-9_{B} | 41.4% | 61.7% | 56.5% |
| L_{LAMA} 3.1-8B | 35.7% | 57.4% | 53.5% |
| L_{LAMA} 3.1-70_{B} | 49.9% | 74.2% | 69.0% |
| GPT-4O-MINI | 43.1% | 70.8% | 66.3% |
| G_{EMINI} 1.5-F | 49.7% | 71.9% | 67.0% |
| C_{LAUDE} 3.5-S | 56.3% | 78.2% | 72.4% |
| GPT-4_{O} | 55.2% | 72.0% | 68.0% |

Table 2 shows example results of evaluating LLMs on contextual settings. CLAUDE 3.5-S achieves the best overall performance in both settings, with a 3.0% improvement from 72.6% to 75.6%. In the contextual setting, most open-source models-including CODELLAMA-13B, STARCODER2-15B, MISTRAL-7B, QWEN 2.5CI-14B, and CODESTRAL-22B-exhibit a sharp performance drop when the input length exceeds 8 k tokens. Examination of model outputs in these cases reveals an increased likelihood of generating incoherent or gibberish responses as input length grows. The prompt template remains consistent across both context-free and contextual settings; the only difference is the addition of code snippets in the contextual version.

TABLE 2
BER on Task I in Contextual Setting

| Max | | | | | | | | | Δₘₐₓ | Δₘᵢₙ |
|---|---|---|---|---|---|---|---|---|---|---|
| Len | Model | PO | 4k | 8k | 16k | 32k | 64k | Best | (↑) | (↑) |
| 8k | CODEGEMMA-7B | 43.7% | 40.6% | 41.5% | — | — | — | 43.7% | −2.2% | −3.1% |
| 16k | MAGICODER 6.7B | 34.3% | 33.0% | 34.2% | 31.0% | — | — | 34.3% | −0.1% | −3.3% |
| 16k | CODELLAMA-13B | 42.3% | 41.7% | 42.3% | 12.2% | — | — | 42.3% | 0.0% | −30.1% |
| 16k | STARCODER2-15B | 41.1% | 37.3% | 25.0% | 25.4% | — | — | 41.1% | −3.8% | −16.1% |
| 32k | MISTRAL-7B | 37.2% | 34.1% | 36.2% | 12.2% | 12.6% | — | 37.2% | −1.0% | −25.0% |
| 32k | QWEN 2.5CI-14B | 59.8% | 59.2% | 60.4% | 31.0% | 30.7% | — | 60.4% | 0.6% | −29.1% |
| 32k | CODESTRAL-22B | 63.3% | 65.0% | 64.2% | 22.3% | 22.1% | — | 65.0% | 1.7% | −41.2% |
| 131k+ | YI-CODER-9B | 56.5% | 55.6% | 53.4% | 43.9% | 40.2% | 40.6% | 56.5% | −0.9% | −16.3% |
| 131k | LLAMA 3.1-8B | 53.5% | 52.1% | 51.3% | 49.1% | 49.0% | 47.3% | 53.5% | −1.4% | −6.2% |
| 131k | LLAMA 3.1−-0B | 69.0% | 71.3% | 71.1% | 72.7% | 71.7% | 70.5% | 72.7% | 3.7% | 1.5% |
| 131k | GPT-40-MINI | 66.3% | 66.0% | 67.3% | 65.3% | 66.7% | 67.7% | 67.7% | 1.4% | −1.0% |
| 131k+ | GEMINI 1.5-F | 67.0% | 67.6% | 66.6% | 66.0% | 66.0% | 66.2% | 67.6% | 0.6% | −1.0% |
| 131k | CLAUDE 3.5-S | 72.4% | 71.5% | 73.4% | 73.4% | 74.4% | 75.4% | 75.4% | 3.0% | −0.9% |
| 131k | GPT-40 | 68.0% | 71.0% | 71.5% | 70.9% | 69.8% | 67.2% | 71.5% | 3.5% | −0.8% |

Two metrics are defined for Task II and Task III: Execution Rate, which measures whether the generated code can be parsed and executed without errors, and Success Rate, which additionally evaluates whether the generated output satisfies the task specification. For Task II, success is determined by the presence of the required target in the generated code, while for Task III, it is based on achieving code coverage. Success Rate results using promptfull are shown in Table 3 and promptₚₐᵣₜ in Table 4. In the context-free setting, models receive no contextual information—not even the “file_name” necessary for task completion. Most models show a notable performance gain when moving from context-free to 8 k input length. At 8 k, CLAUDE 3.5-S reaches a strong performance of 46.2%, outperforming the next-best model, GPT-40, by 9.0%. Some models—including CODEGEMMA-7B, CODELLAMA-13B, LLAMA 3.1-8B, and GEMINI 1.5-F—show little to no improvement or even slight regression. Peak performance is achieved by CLAUDE 3.5-S and GPT-4O at 32 k and 64 k input lengths, respectively. However, starting at 16 k, models such as CODELLAMA-13B, MISTRAL-7B, QWEN 2.5CI-14B, and CODESTRAL-22B exhibit a noticeable decline in performance.

The success rate for Task III is shown in the rightmost two columns of Table 3. GPT-40 achieves the highest performance in the 64 k context setting with a success rate of 32.7%, while none of the open-source models exceed 10% on this task. CLAUDE 3.5-S and GPT-40-MINI demonstrate improved performance with longer context lengths. To evaluate whether LLMs can meet the coverage requirements, we compare execution rate and success rate in Table 4. Across models, the gap between successful execution and satisfying all coverage requirements ranges from 5% to 10%. A test case is counted as successful only if it fulfills the coverage requirements for all code blocks. The observed gap between execution and success rates indicates that most generated test cases fail to meet full coverage criteria.

TABLE 3
Success rate on Task II and Task III

| | Task II | | | | | | | | | |
|---|---|---|---|---|---|---|---|---|---|---|
| | Performance at Max Seq | | | | | | Ctx Util | | Task III | |
| | Length | | | | | | Δₘₐₓ | Δₘᵢₙ | Perf | |
| Model | PO | 8k | 16k | 32k | Best | 64k | (↑) | (↑) | 64k | 128k |
| CODEGEMMA-7B | 14.9% | 10.5% | — | — | — | 14.9% | −4.4% | −4.4% | — | — |
| MAGICODER 6.7B | 13.7% | 20.2% | 0.0% | — | — | 20.2% | 6.5% | −13.7% | — | — |
| CODELLAMA-13B | 8.4% | 8.4% | 0.0% | — | — | 8.4% | 0.0% | −8.4% | — | — |
| STARCODER2-15B | 13.8% | 19.1% | 8.5% | — | — | 19.1% | 5.3% | −5.3% | — | — |
| MISTRAL-7B | 8.4% | 11.6% | 0.0% | 0.0% | — | 11.6% | 3.2% | −8.4% | — | — |
| QWEN 2.5CI-14B | 23.2% | 25.3% | 0.0% | 0.0% | — | 25.3% | 2.1% | −23.2% | — | — |
| CODESTRAL-22B | 20.0% | 28.4% | 0.0% | 0.0% | — | 28.4% | 8.4% | −20.0% | — | — |
| YI−CODER-9B | 14.7% | 20.0% | 14.7% | 13.7% | 13.7% | 20.0% | 5.3% | −1.0% | 4.7% | 3.7% |
| LLAMA 3.1-8B | 5.3% | 5.3% | 4.2% | 9.5% | 5.3% | 9.5% | 4.2% | −1.1% | 1.9% | 0.9% |
| LLAMA 3.1-70B | 12.9% | 14.9% | 13.8% | 24.7% | 18.3% | 24.7% | 11.8% | 0.9% | 6.5% | 3.7% |
| GPT-40-MINI | 17.0% | 22.3% | 25.5% | 26.6% | 25.5% | 26.6% | 9.6% | 5.3% | 19.6% | 21.5% |
| GEMINI 1.5-F | 17.9% | 17.9% | 23.2% | 21.1% | 16.8% | 23.2% | 5.3% | −1.1% | 28.0% | 27.1% |
| CLAUDE 3.5-S | 26.9% | 46.2% | 39.8% | 48.4% | 46.2% | 48.4% | 21.5% | 12.9% | 29.0% | 30.8% |
| GPT-40 | 28.7% | 37.2% | 42.6% | 40.9% | 48.4% | 48.4% | 19.7% | 8.5% | 32.7% | 31.8% |

TABLE 4
Success rate and execution rate of models on Task III

| | |
|---|---|
| Success Rate | Execution Rate |

| Model | 64k | 128k | 64k | 128k |
|---|---|---|---|---|
| Y_{I}-C_{ODER}-9_{B} | 4.7% | 3.7% | 11.2% | 8.4% |
| L_{LAMA} 3.1-8B | 1.9% | 0.9% | 2.8% | 4.7% |
| L_{LAMA} 3.1-70B | 6.5% | 3.7% | 8.4% | 10.3% |
| GPT-4O-MINI | 19.6% | 21.5% | 25.2% | 25.2% |
| G_{EMINI} 1.5-F | 28.0% | 27.1% | 38.3% | 36.4% |
| C_{LAUDE} 3.5-S | 29.0% | 30.8% | 34.6% | 35.5% |
| GPT-4_{O} | 32.7% | 31.8% | 42.1% | 39.3% |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A computer-implemented method of operating a structured testing pipeline for validating a code generation artificial intelligence (AI) agent, the method comprising:
obtaining, from the code generation AI agent, a suite of software source code files;
decomposing, by a code testing AI agent, at least one code test file into one or more test components;
generating, by the code testing AI agent, coverage information indicating a coverage percentage that each of the one or more test component covers at least one software source code file;
generating, by the code testing AI agent, a test code by performing at least one of:
predicting one or more masked elements in an assertion statement of a test component,
completing the test code based on a given function of at least one software source code file, or
completing the test code that covers one or more code blocks in one or more software source code files;
evaluating the code testing AI agent based at least on an execution result of the test code;
performing software testing, by the validated code testing AI agent, the suite of software source code files; and
deploying the suite of software source code files on a computing environment.

2. The computer-implemented method of claim 1, wherein each of the one or more test components includes a shared setup code component and a test function, and wherein the decomposing the at least one code test file comprises preserving the shared setup code component and removing peer test functions from an individual test component.

3. The computer-implemented method of claim 1, wherein the one or more masked elements in an assertion statement of a test component is predicted by the code testing AI agent based on a task prompt combining a setup code component and a test function of at least one code component, the one or more masked elements, and at least one or more software source code files as a context.

4. The computer-implemented method of claim 3, wherein the execution result comprises one or more of:
a match rate that the predicted one or more masked elements match with the one or more masked elements;
an execution rate that measures whether the assertion statement filled with the predicted one or more masked elements executes successfully; and
a context utility rate that measures a performance change given a longer context.

5. The computer-implemented method of claim 1, wherein the completing the test code based on a given function of at least one software source code file further comprises:
generating the test code by the code testing AI agent based on an input combining a setup code component and a test function of at least one code component, a first specification describing the given function and one or more code snippets relating to the test function as a context.

6. The computer-implemented method of claim 5, wherein the completing the test code that covers one or more code blocks in one or more software source code files further comprises:
generating the test code by the code testing AI agent based on an input combining a setup code component and a test function of at least one code component, a second specification describing one or more references to the one or more code blocks in the one or more software source code files, and one or more code snippets relating to the test function as a context.

7. The computer-implemented method of claim 6, wherein the execution result comprises one or more of:
an execution rate that measures whether the test code is executed successfully; and
a success rate that measures whether the test code meets conditions in the first specification or the second specification.

8. The computer-implemented method of claim 1, wherein the validating the code testing AI agent comprises discarding the code testing AI agent when the execution result fails to meet a pre-defined threshold.

9. The computer-implemented method of claim 1, further comprising:
generating corresponding execution results for a plurality of code testing AI agents; and
validating the code testing AI agent having a highest execution metric.

10. The computer-implemented method of claim 1, further comprising:
Instantiating a software engineering automation pipeline comprising at least the code generation AI agent and the code testing AI agent,
wherein the code generation AI agent and the code testing AI agent are built on different generative language models.

11. A system for operating a structured testing pipeline for validating a code generation artificial intelligence (AI) agent, the system comprising:
a memory storing the code generation AI agent and a code testing AI agent, and a plurality of processor-executable instructions for operating the code generation AI agent and the code testing AI agent;
one or more processors executing the instructions to perform operations comprising:
obtaining, from the code generation AI agent, a suite of software source code files;
decomposing, by the code testing AI agent, at least one code test file into one or more test components;
generating, by the code testing AI agent, coverage information indicating a coverage percentage that each of the one or more test component covers at least one software source code file;
generating, by the code testing AI agent, a test code by performing at least one of:
predicting one or more masked elements in an assertion statement of a test component,
completing the test code based on a given function of at least one software source code file, or
completing the test code that covers one or more code blocks in one or more software source code files;
evaluating the code testing AI agent based at least on an execution result of the test code;
performing software testing, by the validated code testing AI agent, the suite of software source code files; and
deploying the suite of software source code files on a computing environment.

12. The system of claim 11, wherein each of the one or more test components includes a shared setup code component and a test function, and wherein the operation of decomposing the at least one code test file comprises preserving the shared setup code component and removing peer test functions from an individual test component.

13. The system of claim 11, wherein the one or more masked elements in an assertion statement of a test component is predicted by the code testing AI agent based on a task prompt combining a setup code component and a test function of at least one code component, the one or more masked elements, and at least one or more software source code files as a context.

14. The system of claim 13, wherein the execution result comprises one or more of:
a match rate that the predicted one or more masked elements match with the one or more masked elements;
an execution rate that measures whether the assertion statement filled with the predicted one or more masked elements executes successfully; and
a context utility rate that measures a performance change given a longer context.

15. The system of claim 11, wherein the operation of completing the test code based on a given function of at least one software source code file further comprises:
generating the test code by the code testing AI agent based on an input combining a setup code component and a test function of at least one code component, a first specification describing the given function and one or more code snippets relating to the test function as a context.

16. The system of claim 15, wherein the operation of completing the test code that covers one or more code blocks in one or more software source code files further comprises:
generating the test code by the code testing AI agent based on an input combining a setup code component and a test function of at least one code component, a second specification describing one or more references to the one or more code blocks in the one or more software source code files, and one or more code snippets relating to the test function as a context.

17. The system of claim 16, wherein the execution result comprises one or more of:
an execution rate that measures whether the test code is executed successfully; and
a success rate that measures whether the test code meets conditions in the first specification or the second specification.

18. The system of claim 11, wherein the operation of validating the code testing AI agent comprises discarding the code testing AI agent when the execution result fails to meet a pre-defined threshold.

19. The system of claim 11, wherein the operations further comprise:
generating corresponding execution results for a plurality of code testing AI agents; and
validating the code testing AI agent having a highest execution metric.

20. A non-statutory processor-readable medium storing a plurality of processor-executable instructions for operating a structured testing pipeline for validating a code generation artificial intelligence (AI) agent, the instructions being executed by one or more processors to perform operations comprising:
obtaining, from the code generation AI agent, a suite of software source code files;
decomposing, by a code testing AI agent, at least one code test file into one or more test components;
generating, by the code testing AI agent, coverage information indicating a coverage percentage that each of the one or more test component covers at least one software source code file;
generating, by the code testing AI agent, a test code by performing at least one of:
predicting one or more masked elements in an assertion statement of a test component,
completing the test code based on a given function of at least one software source code file, or
completing the test code that covers one or more code blocks in one or more software source code files;
evaluating the code testing AI agent based at least on an execution result of the test code;
performing software testing, by the validated code testing AI agent, the suite of software source code files; and
deploying the suite of software source code files on a computing environment.
